(19) United States
(12) Patent Application Publication
(10) Pub. No.: US 2019/0057369 A1
(43) Pub. Date: Feb. 21, 2019

(54) SALES DATA PROCESSING APPARATUS, SALES DATA PROCESSING METHOD, AND RECORDING MEDIUM

(71) Applicant: CASIO COMPUTER CO., LTD., Tokyo (JP)

(72) Inventor: Takehiko YAJIMA, Tokyo (JP)

(73) Assignee: CASIO COMPUTER CO., LTD., Tokyo (JP)

(21) Appl. No.: 16/025,877

(22) Filed: Jul. 2, 2018

(30) Foreign Application Priority Data
Aug. 21, 2017 (JP) 2017-158767

(51) Int. Cl. G06Q 20/20

(52) U.S. Cl. CPC G06Q 20/209

(57) ABSTRACT

A sales data processing apparatus including: communication unit configured to transmit sales data to an external apparatus; and a processor configured to cause a predetermined printer to print the sales data, wherein the processor causes the printer to print, together with the sales data, information indicating whether the sales data has been transmitted via the communication unit.

### BACKGROUND

### 1. Technical Field

The present invention relates to a sales data processing apparatus, a sales data processing method, and a recording medium.

### 2. Related Art

In recent years, Bluetooth (registered trademark) Low Energy (hereinafter, can be referred to as “BLE”) has been installed in smartphones. Thus, installation of BLE in electronic cash registers has been considering in order to communicate with smartphones. This installation enables smartphones to save the content conventionally printed on paper as electronic data, and to transmit it to an external server apparatus.

Problem to be solved in Abstract of JP 2009-176309 A describes that “the consistency of sales totalization by a terminal and sales totalization of a vending machine as a whole is to be easily attained.”

Furthermore, Solution in the same document describes that “a vending machine includes a communication unit that transmits and receives data to/from a terminal so that a product is purchased by a terminal 5, a vending machine control unit 1 that controls sales operation of a vending machine 100, and a communication control unit 4 that processes various types of data between the vending machine control unit and the communication unit, in which a center apparatus requests the communication control unit to transmit data in a second storage unit at a predetermined interval, and the communication control unit transmits, in response to the data request from the center apparatus, sales data in which adjustment data is added to the sales data to the center apparatus, transmits a result of the transmission to the center apparatus to the vending machine control unit, and prints the result of the transmission by a printer 7.”

There is known a technique for transmitting sales data to an external apparatus and printing it on a sheet as disclosed in JP 2009-176309 A. However, it is unclear whether the sales data has been transmitted to the external apparatus from the sheet on which the sales data are printed. In many cases, sales data is deleted from an electronic cash register in a short time. If the sales data has not been saved in a smartphone or the like, the sales data is easily lost.

### SUMMARY

An embodiment of the present invention is a sales data processing apparatus including: communication unit configured to transmit sales data to an external apparatus; and a processor configured to cause a predetermined printer to print the sales data, wherein the processor causes the printer to print, together with the sales data, information indicating whether the sales data has been transmitted via the communication unit.

### BRIEF DESCRIPTION OF THE DRAWINGS

FIG. 1 is a schematic diagram of a system in a first embodiment;

FIG. 2 is an external view of an electronic cash register in the first embodiment;

FIG. 3 is a block diagram showing a configuration of the electronic cash register;

FIG. 4 is an external view of a mode switch;

FIG. 5 is a table showing a configuration of a save-destination memory;

FIG. 6 is a table showing a configuration of a transmission-destination memory;

FIG. 7 is a diagram showing a display at the time of adjustment;

FIG. 8 is a diagram showing the display when a smartphone has been detected at the time of adjustment;

FIG. 9 is a diagram showing the display when a smartphone and a memory card have been detected at the time of adjustment;

FIG. 10 is a sequence diagram showing adjustment operation of the system;

FIG. 11 is a flowchart (No. 1) showing adjustment processing of the electronic cash register;

FIG. 12 is a flowchart (No. 2) showing the adjustment processing of the electronic cash register;

FIG. 13 is a flowchart (No. 3) showing the adjustment processing of the electronic cash register;

FIG. 14 is a diagram showing an adjustment report showing that sales data has been transmitted and saved;

FIG. 15 is a diagram showing an adjustment report showing that sales data has been untransmitted and unsaved;

FIG. 16 is a diagram showing an inspection report showing that sales data has been transmitted and saved;

FIG. 17 is a diagram showing an inspection report showing that sales data has been untransmitted and unsaved;

FIG. 18 is an external view of an electronic cash register in a second embodiment;

FIG. 19 is a block diagram showing a configuration of the electronic cash register;

FIG. 20 is a diagram showing a touch panel display at the time of adjustment; and

FIG. 21 is a diagram showing the touch panel display when a smartphone and a memory card are detected at the time of adjustment.

### DETAILED DESCRIPTION

Hereinafter, embodiments for carrying out the present invention will be described in detail with reference to the drawings.

### First Embodiment

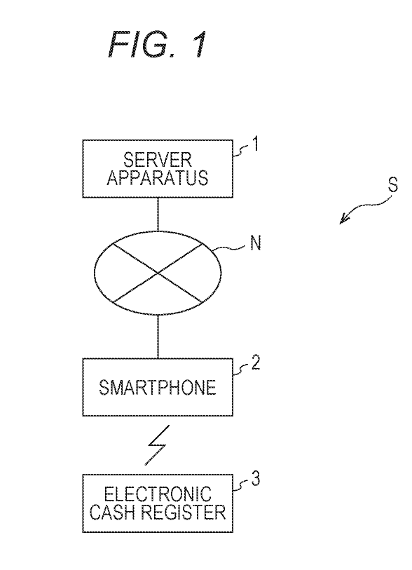

FIG. 1 is a schematic diagram of a system in a first embodiment.

In a system S, a server apparatus 1 and a smartphone 2 are connected via a network N, and the smartphone 2 and an electronic cash register 3 are connected so as to communicate with each other. The electronic cash register 3 in the first embodiment transmits an adjustment report and an inspection report as electronic data and prints them on a sheet.

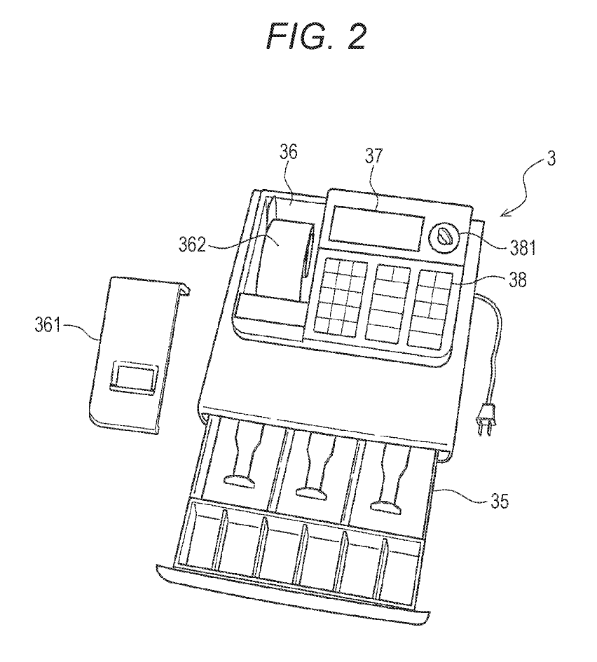

FIG. 2 is an external view of the electronic cash register 3 in the first embodiment.

The electronic cash register 3 is configured by disposing a casing on a drawer 35. The drawer 35 can be disposed separately from the casing of the electronic cash register 3.

A printer 36 is disposed on the left side of the casing, and a keyboard 38, a display 37, and a mode switch 381 are disposed on the right side thereof. Note that, rolled paper (a receipt sheet) 362 is provided inside the printer 36 under a printer cover 361.

An operator of the electronic cash register 3 can register a product by inputting the unit price and department of the product through the keyboard 38, displaying the subtotal, and then inputting the received money. When the product is registered, the electronic cash register 3 pulls out the drawer 35 to receive the money.

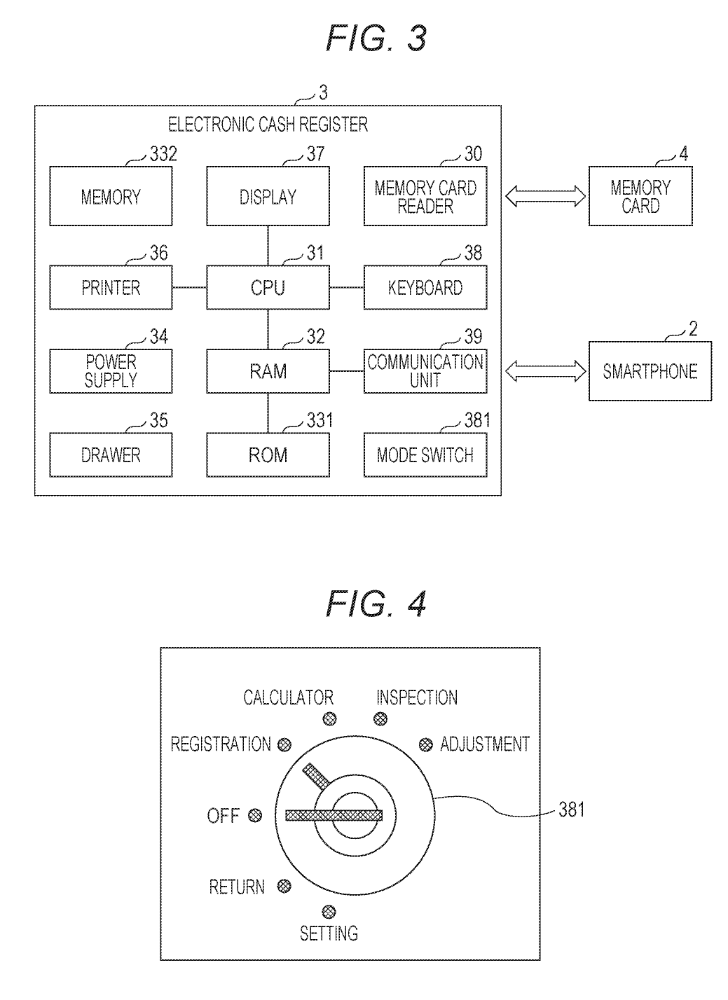

FIG. 3 is a block diagram showing a configuration of the electronic cash register 3.

The electronic cash register 3 includes a central processing unit (CPU) 31, a random-access memory (RAM) 32, a read only memory (ROM) 331, a memory 332, a power supply 34, a drawer 35, a printer 36, a display 37, a keyboard 38, a communication unit 39, and a memory card reader 30, and these units are connected by a bus or the like. The electronic cash register 3 further includes a mode switch 381. In the drawings, the mode switch 381 may be referred to as a “mode SW”.

The CPU 31 develops, in the work memory of the RAM 32, an application program designated from various application programs corresponding to the electronic cash register 3 stored in the ROM 331, the memory 332, and the like, and various instructions input from the keyboard 38. The CPU 31 further performs, in response to the input instructions and input data, various types of processing in accordance with the application program developed in the work memory, stores the processing result in the work memory of the RAM 32, and displays it on the display 37. Then, the CPU 31 saves, in a save destination in the RAM 32 instructed from the keyboard 38, the processing result stored in the work memory.

The CPU 31 functions as a print control unit that causes the printer 36 to print sales data. When an adjustment mode or an inspection mode is designated by the mode switch 381, the CPU 31 functions as an input control unit that accepts the designation as a print instruction of sales data.

The keyboard 38 includes various function keys such as a department key, a receiving cash key, and a clear key, and numeric input keys, and outputs a depression signal generated by pressing each key to the CPU 31.

Note that, any device with which an input instruction is performed can be used instead of the keyboard 38. In the case of a device other than the keyboard 38, for example, a touch panel (touch screen) may sense the coordinates instructed by an input pen, a fingertip, or the like and detect the instructed position coordinates by a coordinate reading principle such as an electromagnetic induction system, a magnetostriction system, or a pressure sensitive system.

The mode switch 381 is used to determine the operation mode of the electronic cash register 3 and will be described in detail with reference to FIG. 4.

The power supply 34 is, for example, a DC power supply circuit that converts commercial AC power into DC power, and supplies the DC power to the units of the electronic cash register 3.

The drawer 35 is a storage unit that stores cash such as coins and bills. The drawer 35 is unlocked and locked by operating the electronic cash register 3.

The display 37 in the first embodiment is constituted by seven-segment liquid crystal display elements, luminous elements, or the like, and supports display of numbers and simple alphabets. The electronic cash register 3 generates a signal based on display data input from the CPU 31 and performs various displays on the display 37.

The printer 36 is, for example, a thermal transfer printer, and prints receipt information on the rolled paper (receipt sheet) 362 according to an instruction from the CPU 31 and outputs it. The printer 36 further prints an adjustment report and an inspection report on a receipt sheet according to the print instruction from the CPU 31.

The drawer 35 is a part that stores cash, and is pulled out by an operator operating the electronic cash register 3.

The memory 332 is constituted by a rewritable storage medium such as a magnetic or optical storage medium, or a semiconductor memory. The memory 332 stores system programs, various application programs corresponding to these systems, data processed by these programs, and the like. The memory 332 further includes a save-destination storing location 51 and a transmission-destination storing location 52.

The communication unit 39 is a communication unit that supports, for example, BLE or the like, and is capable of mutual communication with the smartphone 2 (an example of an external apparatus). The communication unit 39 functions as a communication unit that transmits sales data to the smartphone 2.

The CPU 31 of the electronic cash register 3 transmits program data and sales data to an information terminal such as the smartphone 2. Thereafter, the CPU 31 stores the data including the type of the transmitted data (program data, inspection data, adjustment data, or the like), the transmission destination, and the date and time as a transmission record in the transmission-destination storing location 52 in the memory 332. When the operator (store clerk) performs inspection operation of a program, inspection operation of sales, or adjustment operation, the CPU 31 refers to transmission records in the transmission-destination storing location 52, and prints, when there is a transmission record having the same data type, the information about the transmission destination, the date and time, and the like in a report. When there is no transmission record having the target data type in the transmission-destination storing location 52, the CPU 31 prints the fact that the data is untransmitted in the report. It is selectable to update the transmission records in the transmission-destination storing location 52 every time the data is transmitted or to initialize the transmission records at an arbitrary cycle (one day, one week, or the like).

The memory card reader 30, into/from which the memory card 4 can be inserted and removed, is capable of reading and writing a desired file from/to the inserted memory card 4. The memory card reader 30 is a storage control unit that stores sales data in the memory card 4 (external storage medium).

The CPU 31 of the electronic cash register 3 saves program data and sales data in the memory card 4 through the memory card reader 30. Thereafter, the CPU 31 stores the data including the type of the saved data (program data, inspection data, adjustment data, or the like), the transmission destination, and the date and time as a save record in the save-destination storing location 51 in the memory 332.

When the operator performs inspection operation of a program, inspection operation of sales, or adjustment operation, the CPU 31 refers to save records in the save-destination storing location 51, and prints, when there is a save record having the same data type, the information about the save destination, the date and time, and the like in a report. When there is no save record having the target data type in the save-destination storing location 51, the CPU 31 prints the fact that the data is unsaved in the report. It is selectable to update the save record in the save-destination storing location 51 every time the data is saved or to initialize the save record at an arbitrary cycle (one day, one week, or the like).

Note that, a part or all of the programs, data, and the like stored in the memory 332 may be received from another device such as a server or a client via a transmission medium such as a network line and stored. In addition, the memory 332 may be a recording medium of a server built on the network. Furthermore, each program may be transmitted to a server and a client via a transmission medium such as a network line, and installed in these devices.

FIG. 4 is an external view of the mode switch 381.

The mode switch 381 switches the operation modes of the electronic cash register 3 by inserting an accompanying mode key thereinto. The operation modes of the electronic cash register 3 includes “adjustment”, “inspection”, “calculator”, “registration”, “OFF”, “return”, and “setting”.

“Adjustment” is a mode for performing adjustment of sales with the electronic cash register 3. “Inspection” is a mode for inspecting sales with the electronic cash register 3. “Calculator” is a mode for using the electronic cash register 3 as a calculator. “Registration” is a mode for registering sales with the electronic cash register 3. “OFF” is a mode for turning off the power supply 34 of the electronic cash register 3. “Return” is a mode for performing return processing with the electronic cash register 3. “Setting” is a mode for performing various settings for each store to the electronic cash register 3.

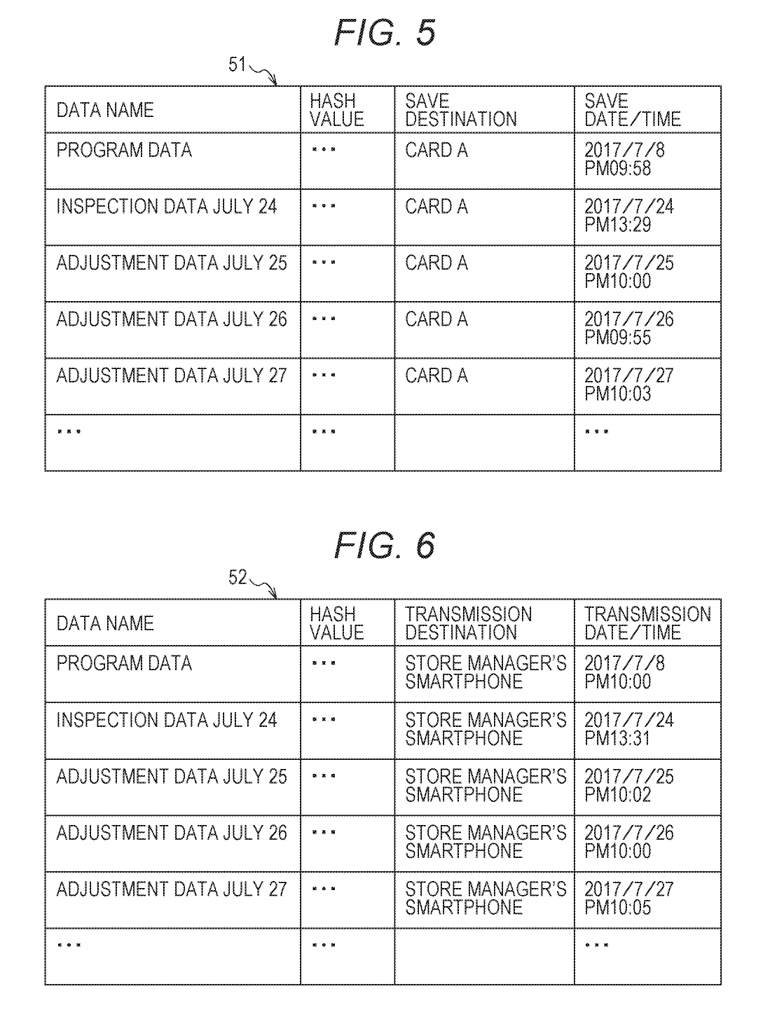

FIG. 5 is a table showing a configuration of the save-destination storing location 51.

The save-destination storing location 51 is constituted by a plurality of records including a data name column, a hash value column, a save destination column, and a save date/time column. In FIG. 5, the columns are arranged in the horizontal direction, and the records are arranged in the vertical direction. Each record indicates one save operation.

The data name column stores the name of the data saved in each save operation.

The hash value column stores the hash value of the data saved in each save operation. The function that derives the hash value may be arbitrary, and is not limited. From the hash value, it is possible to determine whether each data has been saved.

The save destination column stores the information for identifying the memory card 4 which is the save destination in each storage operation. Although the name “card A” is stored in the table, ID information for uniquely identifying the memory card 4 may be used, and the information is not limited.

The save date/time column stores the date and time when each save operation has been performed.

FIG. 6 is a table showing a configuration of the transmission-destination storing location 52.

The transmission-destination storing location 52 is constituted by a plurality of records including a data name column, a hash value column, a transmission destination column, and a transmission date/time column. In FIG. 5, the columns are arranged in the horizontal direction, and the records are arranged in the vertical direction. Each record indicates one transmission operation.

The data name column stores the name of the data transmitted in each transmission operation.

The hash value column stores the hash value of the data transmitted in each transmission operation. The function that derives the hash value may be arbitrary, and is not limited. From the hash value, it is possible to determine whether each data has been transmitted.

The transmission destination column stores the information for identifying the external apparatus (smartphone 2) which is the transmission destination in each transmission operation. Although the name “store manager's smartphone” is stored in the table, ID information for uniquely identifying the smartphone 2 may be used, and the information is not limited.

The transmission date/time column stores the date and time when each transmission operation has been performed.

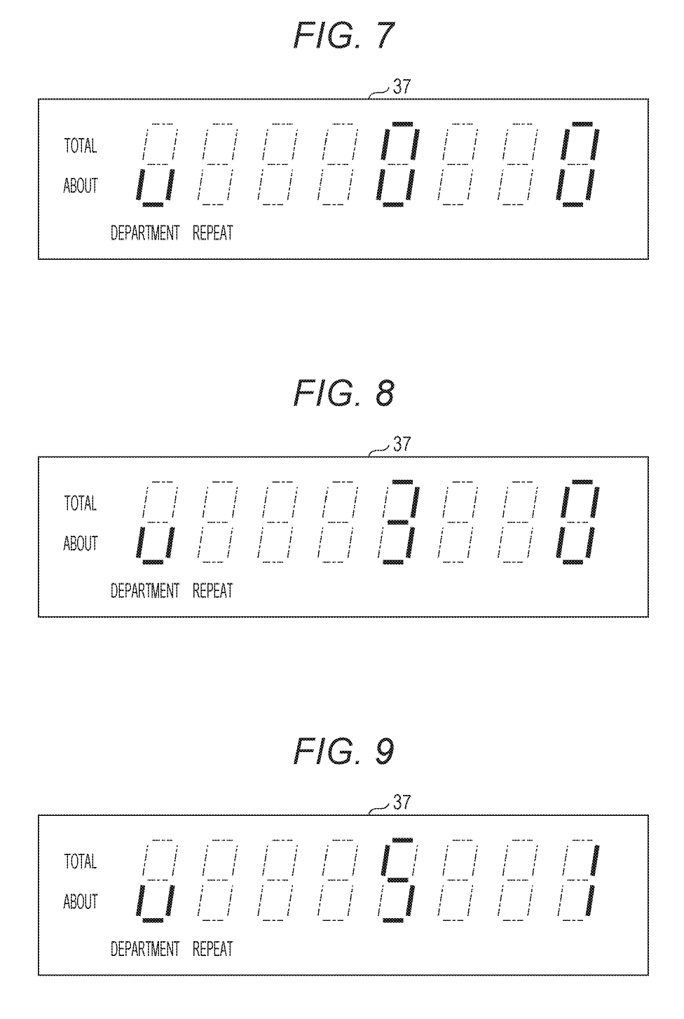

FIG. 7 is a diagram showing the display 37 at the time of adjustment.

The display 37 displays eight-digit numbers by the arrangement of eight seven-segment display elements. The most significant digit displays “u” indicating that the electronic cash register 3 is in the adjustment mode.

The display element for the fourth digit from the right end displays “0”, which means that the radio wave of the smartphone 2 has not been detected.

The display element for the right end (the first digit) displays “0”, which means that the memory card 4 has not been detected.

The display elements for the second, third, and fifth to eighth digits display nothing.

FIG. 8 is a diagram showing the display 37 when the smartphone 2 has been detected at the time of adjustment.

The display element for the fourth digit from the right end displays “3”, which means that the radio wave of the smartphone 2 has been detected and that its radio wave intensity is medium.

The display element for the right end (the first digit) displays “0”, which means that the memory card 4 has not been detected.

The display elements for the second, third, and fifth to eighth digits display nothing.

FIG. 9 is a diagram showing the display 37 when the smartphone 2 and the memory card 4 have been detected at the time of adjustment.

The display element for the fourth digit from the right end displays “5”, which means that the radio wave of the smartphone 2 has been detected and that its radio wave intensity is high.

The display element for the right end (the first digit) displays “1”, which means that the memory card 4 has been detected.

The display elements for the second, third, and fifth to eighth digits display nothing.

From the above, the display element for the fourth digit from the right end displays “0” when the radio wave of the smartphone 2 has not been detected, and displays “1 to 5” as five intensity levels of the radio wave when the radio wave of the smartphone 2 has been detected.

In addition, the display element for the right end (the first digit) displays “0” when the memory card 4 has not been detected, and displays “1” when the memory card 4 has been detected.

In other words, the display element for the fourth digit from the right end functions as an informing unit that informs, when the adjustment mode or the inspection mode is designated, whether the sales data can be transmitted to the smartphone 2 by the communication unit 39.

The display element for the right end (the first digit) functions as an informing unit that informs, when the adjustment mode or the inspection mode is designated, whether the sales data can be saved in the memory card 4 by the memory card reader 30.

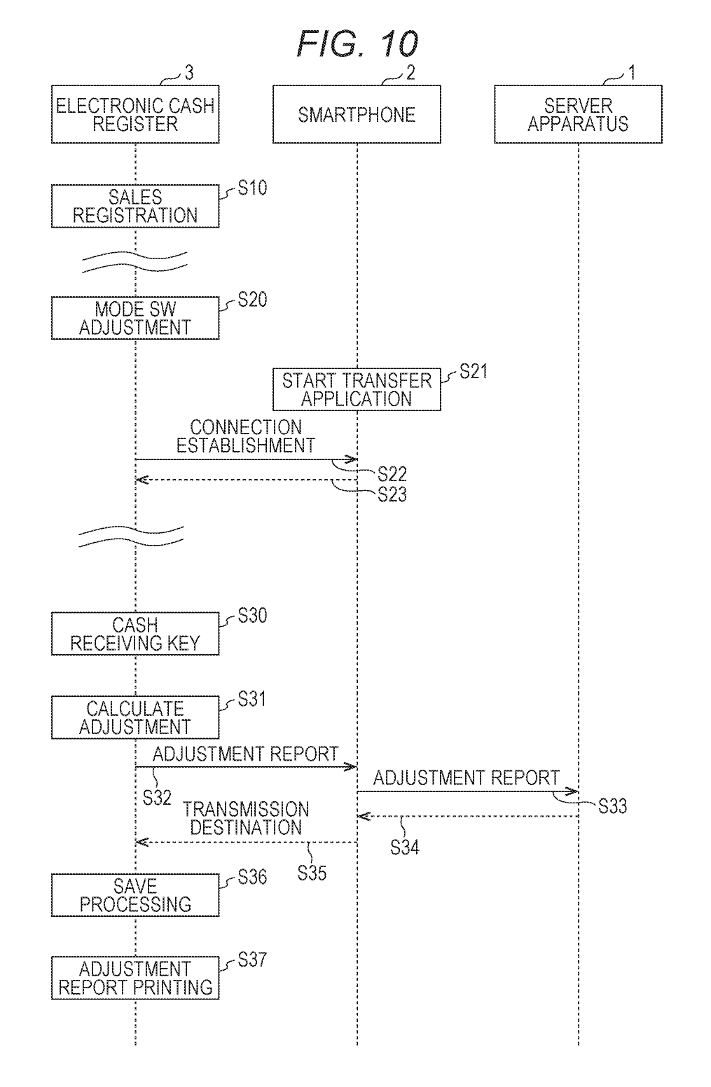

FIG. 10 is a sequence diagram showing adjustment operation of the system.

In step S10, the electronic cash register 3 performs sales registration. The sales registration is normally repeated a plurality of times during the opening hours of the store.

When the opening hours of the store are over, the store clerk who is the operator turns the mode switch 381 (see FIG. 4) to “adjustment” (step S20). The electronic cash register 3 is thereby switched to the adjustment mode.

Next, the store clerk starts a transfer application on the smartphone 2 (step S21). This transfer application is a program for transferring various types of data to the electronic cash register 3.

The electronic cash register 3 transmits a packet to the smartphone 2 to establish communication (step S22). The smartphone 2 responds to the packet (step S23), and a communication session is thereby established between the electronic cash register 3 and the smartphone 2. Although not shown, thereafter, the electronic cash register 3 and the smartphone 2 maintain the communication session by polling. Thus, it is possible for the electronic cash register 3 to determine that the smartphone 2 is communicably connected.

Next, the store clerk presses the receiving cash key of the electronic cash register 3 (step S30). The electronic cash register 3 thereby calculates adjustment data (step S31) and transmits the calculated adjustment report to the smartphone 2 (step S32). When receiving the adjustment report, the smartphone 2 transmits the adjustment report to the server apparatus 1 (step S33). Thus, it is possible for the store clerk to save the adjustment data in the server apparatus 1.

The server apparatus 1 responds to the smartphone 2 that the adjustment report has been received (step S34). The smartphone 2 responds, to the electronic cash register 3, with transmitting the name or identification information of itself as the transmission destination of the adjustment report and that the adjustment report has been received (step S35).

Next, the electronic cash register 3 saves the adjustment report in the memory card 4 through the memory card reader 30 (step S36). Thereafter, the electronic cash register 3 prints the adjustment report with the printer 36 (step S37).

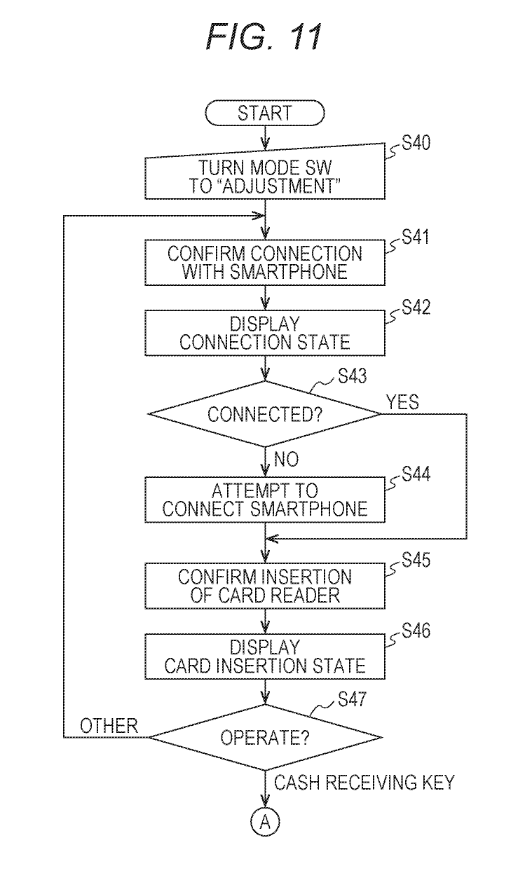

FIGS. 11 to 13 are flowcharts showing adjustment processing of the electronic cash register 3.

The electronic cash register 3 has a function for storing transmission records of program data, inspection data, adjustment data, and the like in a specific area in the memory, and a report issuing function for checking the transmission record for each target data type such as inspection operation or adjustment operation, and printing the transmission history (if the data has been untransmitted, the fact of untransmission) in each report. These functions are described below.

In the adjustment processing, the store clerk turns the mode switch 381 to “adjustment” (step S40). The CPU 31 of the electronic cash register 3 detects that the mode switch 381 has been turned to “adjustment”.

The CPU 31 confirms the connection with the smartphone 2 (step S41), and displays the confirmed connection state on the display 37 (step S42). The connection state of the smartphone 2 is indicated by, for example, the number at the fourth digit in FIGS. 7 to 9 described above. When the number at the fourth digit is “0”, the smartphone 2 has not been connected. When the number at the fourth digit is “1” to “5”, which indicates that the smartphone 2 has been connected and the radio wave intensity.

When the smartphone 2 has not been connected (No in step S43), the CPU 31 attempt to connect the smartphone 2 (step S44). The attempt to connect the smartphone 2 corresponds to, specifically, the processing in step S22 in FIG. 10. When the smartphone 2 has been connected (Yes in step S43), the CPU 31 proceeds to the processing in step S45.

Next, the CPU 31 determines whether the memory card 4 has been inserted in the memory card reader 30 (step S45), and displays the insertion state of the memory card 4 on the display 37 (step S46). The insertion state of the memory card 4 is indicated by, for example, the number at the first digit in FIGS. 7 to 9 described above. When the number at the first digit is “0”, the memory card 4 has not been inserted. When the number at the first digit is “1”, the memory card 4 has been inserted.

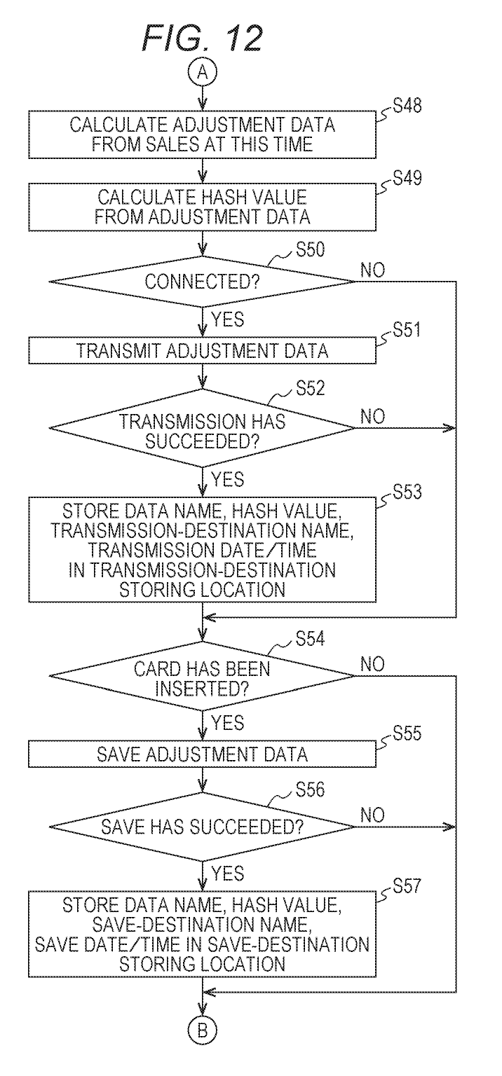

When the receiving cash key of the keyboard 38 has been pressed (receiving cash key in step S47), the CPU 31 proceeds to step S48 in FIG. 12, and when the receiving cash key has not been pressed (other in step S47), the CPU 31 returns to the processing in step S41. Through the processing in steps S41 to S48, it is possible for the store clerk to easily recognize whether the smartphone 2 has been connected and whether the memory card 4 has been inserted.

In step S48 in FIG. 12, the CPU 31 calculates adjustment data from the sales at this time. The CPU 31 further calculates the hash value from the adjustment data (step S49).

When the smartphone 2 has been connected (Yes in step S50), the CPU 31 transmits the adjustment data to the smartphone 2 (step S51). When the transmission of the adjustment data has succeeded (Yes in step S52), the CPU 31 stores the transmission operation in the transmission-destination storing location 52 as a record including the data name, the hash value, the transmission-destination name, and the transmission date/time (step S53).

In step S50, when the smartphone 2 has not been connected (No), the CPU 31 proceeds to the processing in step SM. In the processing in step S52, when the transmission of the adjustment data has failed (No in step S52), the CPU 31 proceeds to the processing in step SM.

When the memory card 4 has been inserted in the memory card reader 30 (Yes in step SM), the CPU 31 saves the adjustment data in the memory card 4 (step S55). When the save of the adjustment data has succeeded (Yes in step S56), the CPU 31 stores the save operation in the save-destination storing location 51 as a record including the data name, the hash value, the save destination name, and the save date/time (step S57).

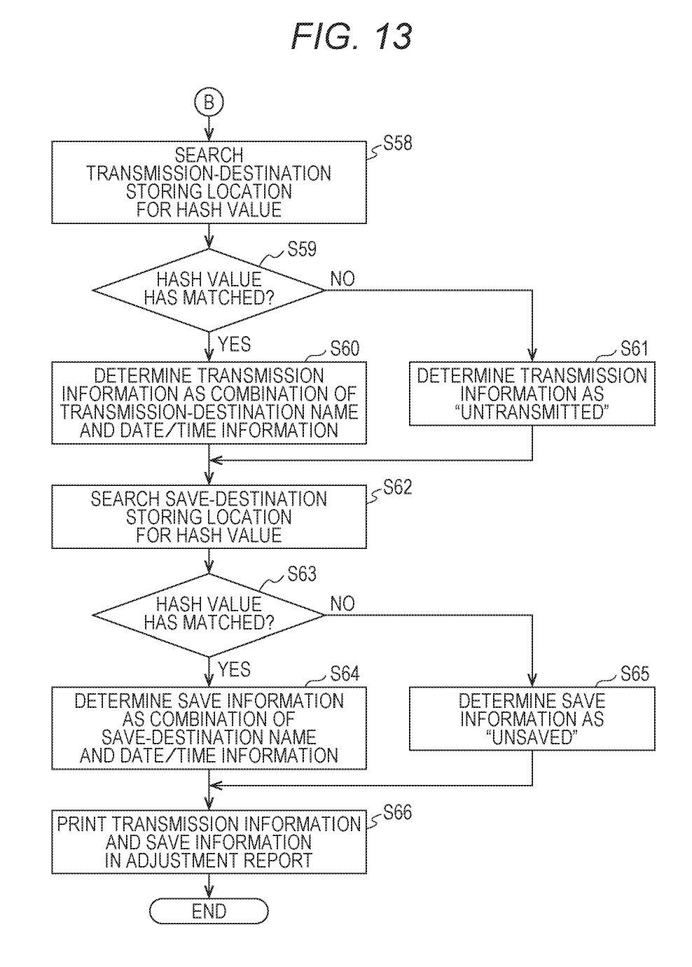

In step S54, when the memory card 4 has not been inserted in the memory card reader 30 (No), the CPU 31 proceeds to the processing in step S58 in FIG. 13. In the processing in step S55, when the save of the adjustment data has failed (No in step S56), the CPU 31 proceeds to the processing in step S58 in FIG. 13.

In step S58 in FIG. 13, the CPU 31 searches the transmission-destination storing location 52 for the hash value of the adjustment data. When the hash value of the adjustment data matches the hash value of any record in the transmission-destination storing location 52, which means that the adjustment record has been transmitted to the smartphone 2.

When the hash value of the adjustment data matches the hash value of any record in the transmission-destination storing location 52 (Yes in step S59), the CPU 31 determines transmission information as a combination of the transmission-destination name and the date/time information (step S60). The transmission information is information to be printed in the adjustment report.

When the hash value of the adjustment data does not match the hash value of any record in the transmission-destination storing location 52 (No in step S59), the CPU 31 determines the transmission information as “untransmitted” (step S61).

In step S62, the CPU 31 searches the save-destination storing location 51 for the hash value of the adjustment data. When the hash value of the adjustment data matches the hash value of any record in the save-destination storing location 51, which means that the adjustment record has been saved in the memory card 4.

When the hash value of the adjustment data matches the hash value of any record in the save-destination storing location 51 (Yes in step S63), the CPU 31 determines save information as a combination of the save-destination name and the date/time information (step S64). The save information is information to be printed in the adjustment report.

When the hash value of the adjustment data does not match the hash value of any record in the save-destination storing location 51 (No in step S63), the CPU 31 determines the save information as “untransmitted” (step S65).

Finally, the CPU 31 prints the transmission information and the save information in the adjustment report (step S66), and terminates the processing in FIG. 13. Thus, it is possible for the store clerk to easily grasp the backup state of the sales data related to the adjustment report by simply browsing the adjustment report printed on the sheet.

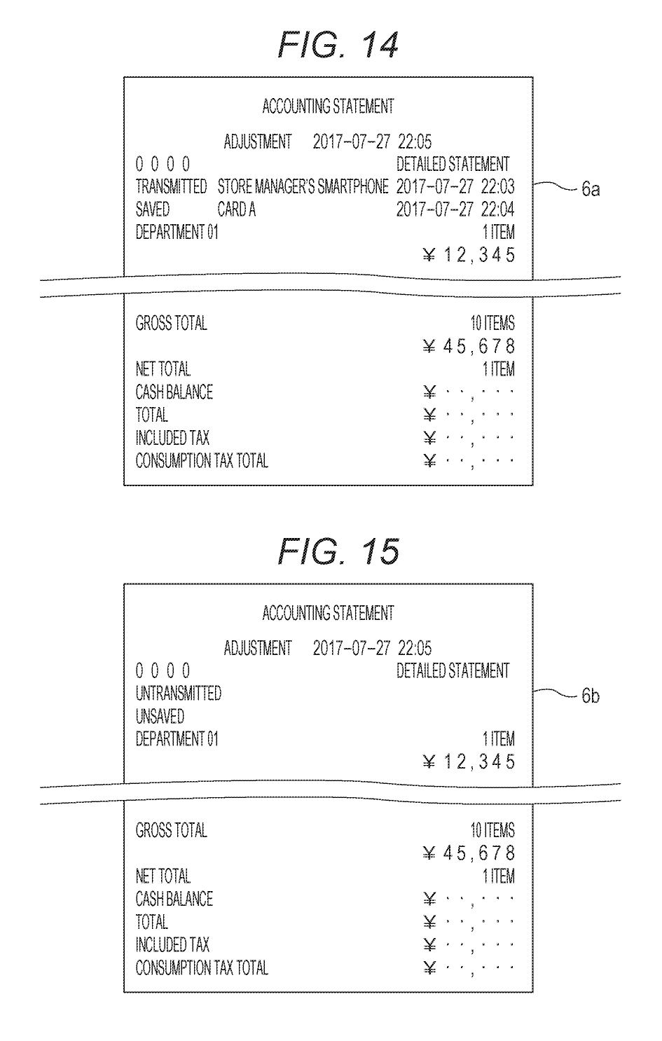

FIG. 14 is a diagram showing an adjustment report 6a showing that sales data has been transmitted and saved.

In the fourth line of the adjustment report 6a, the transmission information described with reference to FIG. 13 is printed. The transmission information is “Transmitted: store manager's smartphone 2017-07-27 22: 03” indicating that the sales data related to the adjustment report 6a has been transmitted to the store manager's smartphone. Here, “store manager smartphone” is information for identifying the smartphone 2 to which the sales data printed in the adjustment report 6a has been transmitted. “2017-07-27 22: 03” indicates the time when the sales data has been transmitted.

In the fifth line of the adjustment report 6a, the save information described with reference to FIG. 13 is printed. The save information is “Saved: card A 2017-07-27 22: 04” indicating that the sales data related to the adjustment report 6a has been saved in the card A. Here, “card A” is information for identifying the memory card 4 in which the sales data printed in the adjustment report 6a has been saved. “2017-07-27 22: 04” indicates the time when the sales data has been saved.

FIG. 15 is a diagram showing an adjustment report 6b indicating that sales data has been untransmitted and unsaved.

In the fourth line of the adjustment report 6b, the transmission information described with reference to FIG. 13 is printed. The transmission information is “Untransmitted” indicating that the sales data related to the adjustment report 6b has not been transmitted and has not been backed up in the smartphone 2.

In the fifth line of the adjustment report 6b, the save information described with reference to FIG. 13 is printed. The save information is “Unsaved” indicating that the sales data related to the adjustment report 6b has not been saved and has not been backed up in the memory card 4.

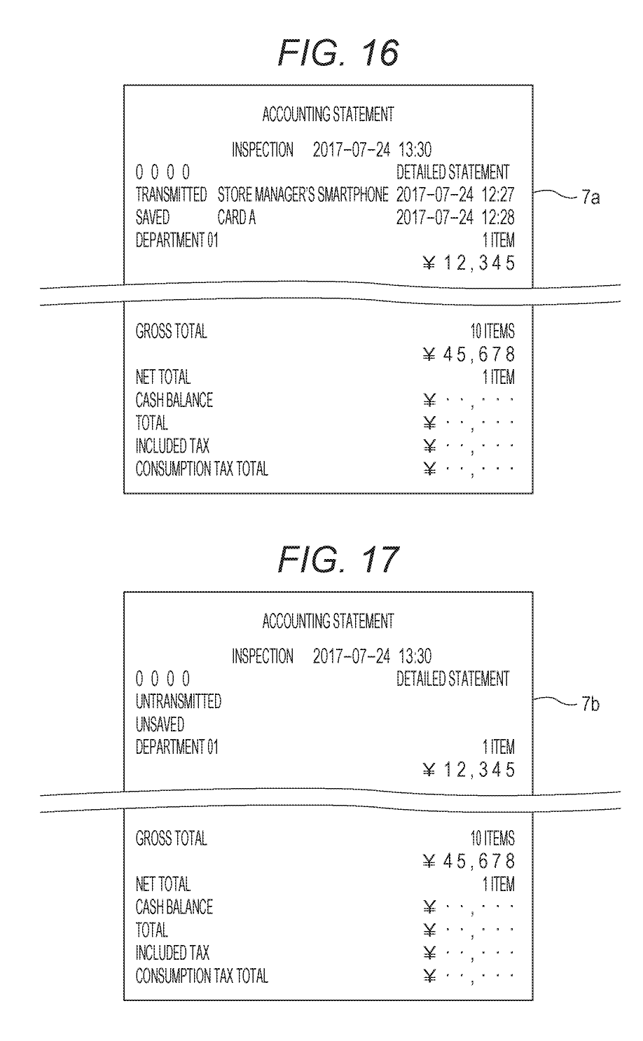

When the store clerk turns the mode switch 381 to “inspection” in step S40 described with reference to FIG. 6, the CPU 31 of the electronic cash register 3 detects that the mode switch 381 has been turned to “inspection”. The sales data totalized in this state is processed as inspection data. An example of an inspection report in which the inspection data is printed is described with reference to FIGS. 16 and 17.

FIG. 16 is a diagram showing an inspection report 7a indicating that sales data has been transmitted and saved.

In the fourth line of the inspection report 7a, the transmission information described with reference to FIG. 13 is printed. The transmission information is “Transmitted: store manager's smartphone 2017-07-24 12:27” indicating that the sales data related to the inspection report 7a has been transmitted to the store manager's smartphone.

In the fifth line of the inspection report 7a, the save information described with reference to FIG. 13 is printed. The save information is “Saved: card A 2017-07-24 12:28” indicating that the sales data related to the inspection report 7a has been saved in the card A.

FIG. 17 is a diagram showing an inspection report 7b showing that sales data has been untransmitted and unsaved.

In the fourth line of the inspection report 7b, the transmission information described with reference to FIG. 13 is printed. The transmission information is “Untransmitted” indicating that the sales data related to the inspection report 7b has not been transmitted and has not been backed up in the smartphone 2.

In the fifth line of the inspection report 7b, the save information described with reference to FIG. 13 is printed. The save information is “Unsaved” indicating that the sales data related to the inspection report 7b has not been saved and has not been backed up in the memory card 4.

### Second Embodiment

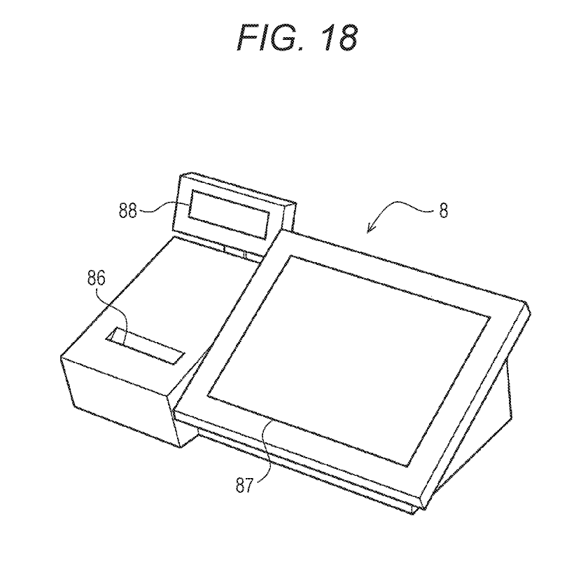

FIG. 18 is an external view of an electronic cash register 8 in a second embodiment.

The electronic cash register 8 is configured to be separated from a drawer (not shown). The drawer is capable of being electrically connected to the electronic cash register 8.

A printer 86 and a customer display 88 are disposed on the left side of the casing, and a touch panel display 87 is disposed on the right side thereof. Unlike the electronic cash register 3 in the first embodiment, software buttons on the touch panel display 87 functions as an input unit.

The operator of the electronic cash register 8 can register a product by inputting the unit price and department of the product through the software buttons on the touch panel display 87, displaying the subtotal, and then inputting the received money. When the product is registered, the electronic cash register 8 pulls out the drawer (not shown) to receive the money.

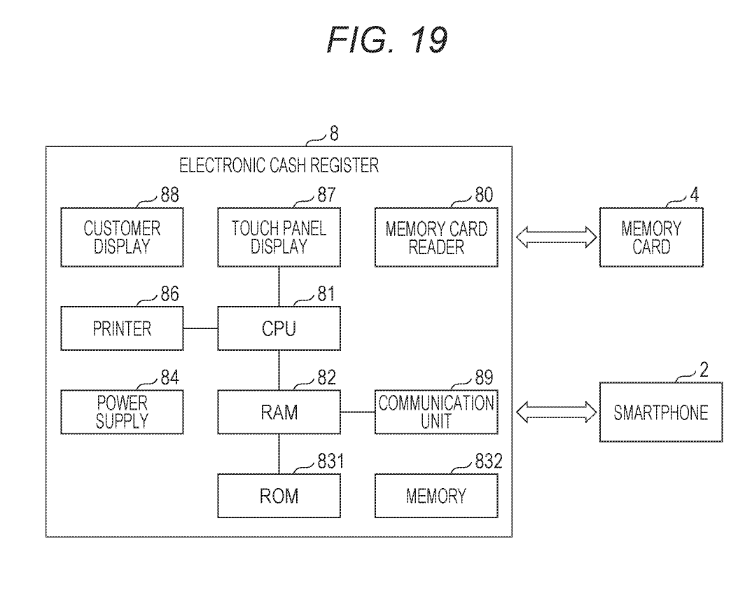

FIG. 19 is a block diagram showing a configuration of the electronic cash register 8.

The electronic cash register 8 includes a CPU 81, a RAM 82, a ROM 831, a memory 832, a power supply 84, a printer 86, a touch panel display 87, a customer display 88, a communication unit 89, and a memory card reader 80, and these units are connected by a bus. Unlike the first embodiment, the electronic cash register 8 does not include a mode switch.

The CPU 81 develops, in the work memory of the RAM 82, an application program designated from various application programs corresponding to the electronic cash register 8 stored in the ROM 831, the memory 832, and the like, and various instructions input from the touch panel display 87. The CPU 81 further performs, in response to the input instructions and input data, various types of processing in accordance with the application program developed in the work memory, stores the processing result in the work memory of the RAM 82, and displays it on the touch panel display 87. Then, the CPU 81 saves, in a save destination in the RAM 82 instructed from the touch panel display 87, the processing result stored in the work memory. The CPU 81 functions as a print control unit that causes the printer 86 to print sales data.

The touch panel display 87 senses the coordinates instructed by an input pen, a fingertip, or the like, detects the instructed position coordinates by a coordinate reading principle such as an electromagnetic induction system, a magnetostriction system, or a pressure sensitive system, and outputs a position signal to the CPU 81.

The power supply 84 is, for example, a DC power supply circuit that converts commercial AC power into DC power, and supplies the DC power to the units of the electronic cash register 8.

The customer display 88 is constituted by a liquid crystal display or an organic electro luminescence (EL) display, and supports display of numbers, characters, and graphics.

The electronic cash register 8 generates a signal based on display data input from the CPU 81 and performs various displays on the customer display 88.

The printer 86 is, for example, a thermal transfer printer, and prints receipt information on rolled paper (a receipt sheet) 362 and outputs it. The printer 86 prints an adjustment report and an inspection report on a receipt sheet according to the instruction from the CPU 81.

The memory 832 is constituted by a rewritable storage medium such as a magnetic or optical storage medium, or a semiconductor memory. The memory 832 stores system programs, various application programs corresponding to these systems, data processed by these programs, and the like. The memory 832 includes a save-destination storing location 51 and a transmission-destination storing location 52.

The communication unit 89 is a communication unit that supports, for example, BLE or the like, and is capable of mutual communication with a smartphone 2 (an example of an external apparatus). The communication unit 89 functions as a communication unit that transmits sales data to the smartphone 2.

When the electronic cash register 8 transmits program data and sales data to an information terminal such as the smartphone 2, the CPU 81 stores the data including the type of the transmitted data (program data, inspection data, adjustment data, or the like), the transmission destination, and the date and time as a transmission record in the transmission-destination storing location 52 in the memory 832. When the operator (store clerk) performs inspection operation of a program, inspection operation of sales, or adjustment operation, the CPU 81 refers to transmission records in the transmission-destination storing location 52, and prints, when there is a transmission record having the same data type, the information about the transmission destination, the date and time, and the like in a report. When there is no transmission record having the target data type in the transmission-destination storing location 52, the CPU 31 prints the fact that the data is untransmitted in the report. It is selectable to update the transmission records in the transmission-destination storing location 52 every time the data is transmitted or to initialize the transmission records at an arbitrary cycle (one day, one week, or the like).

The memory card reader 80, into/from which a memory card 4 can be inserted and removed, is capable of reading and writing a desired file from/to the inserted memory card 4.

When the electronic cash register 8 saves program data and sales data in the memory card 4 through the memory card reader 80, the CPU 81 stores data including the type of the saved data (program data, inspection data, adjustment data, or the like), the transmission destination, and the date and time as a save record in the save-destination storing location 51 in the memory 832.

When the operator performs inspection operation of a program, inspection operation of sales, the CPU 81 refers to save records in the save-destination storing location 51, and prints, when there is a save record having the same data type, the information about the save destination, the date and time, and the like in a report. When there is no save record having the target data type in the save-destination storing location 51, the CPU 31 prints the fact that the data is unsaved in the report. It is selectable to update the save record in the save-destination storing location 51 every time the data is saved or to initialize the save record at an arbitrary cycle (one day, one week, or the like).

Note that, a part or all of the programs, data, and the like stored in the memory 832 may be received from another device such as a server or a client via a transmission medium such as a network line and stored. In addition, the memory 832 may be a recording medium of a server built on the network. Furthermore, each program may be transmitted to a server and a client via a transmission medium such as a network line, and installed in these devices.

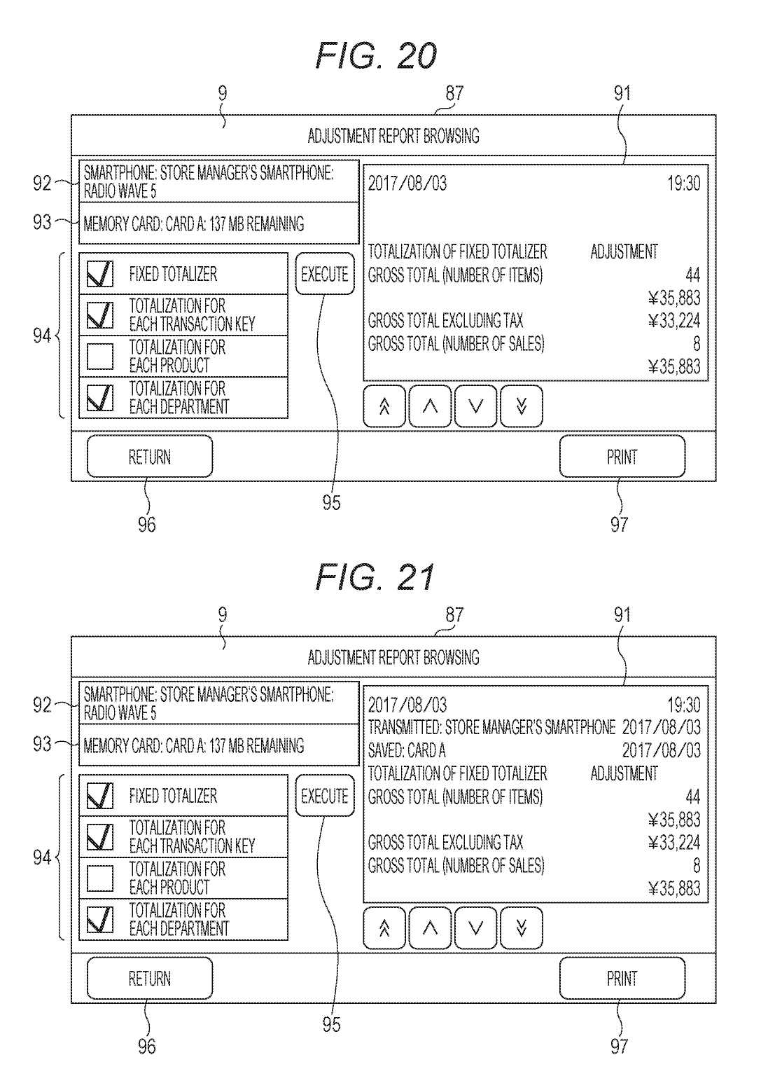

FIG. 20 is a diagram showing the touch panel display 87 when the smartphone 2 and the memory card 4 have been detected at the time of adjustment.

On the touch panel display 87, an adjustment-report browsing screen 9 is displayed.

On the right side of the adjustment-report browsing screen 9, an adjustment-report pane 91 is displayed. The adjustment-report pane 91 is, for example, a print image. When the operator taps a print button 97, the content of the adjustment-report pane 91 is printed on a receipt sheet. When the operator taps a return button 96, the touch panel display 87 displays the original screen (not shown).

The second and third lines of the adjustment-report pane 91 are blank. This indicates that the sales data has not been printed, and neither the transmission state nor the save state has been fixed. Note that, transmission and save of the sales data are performed by tapping the print button 97.

On the upper left side of the adjustment-report browsing screen 9, a smartphone-state text box 92 and a memory-card-state text box 93 are displayed. The smartphone-state text box 92 shows the connection state of the smartphone 2. The memory-card-state text box 93 shows the insertion state of the memory card 4.

With these smartphone-state text box 92 and memory-card-state text box 93, it is possible to easily determine whether the backup is to be performed together with the printing.

Report-totalizing-condition check boxes 94 are used to set the conditions for totalizing an accumulated report. In the drawing, “fixed totalizer”, “totalization for each transaction key”, and “totalization for each department” are selected. By selecting these check boxes and tapping an execute button 95, the conditions for totalizing the accumulated report can be re-set.

FIG. 21 is a diagram showing display on the touch panel display 87 after the adjustment data is printed.

On the touch panel display 87, an adjustment-report browsing screen 9 is displayed.

On the right side of the adjustment-report browsing screen 9, an adjustment-report pane 91 is displayed. Since the operator has tapped the print button 97, the transmission state is printed in the second line of the adjustment-report pane 91, and the save state is printed in the third line. The display content of the adjustment-report pane 91 is the same as the content of the printed adjustment report.

In the second line of the adjustment-report pane 91, the transmission information described with reference to FIG. 13 is printed. The transmission information is “Transmitted: store manager's smartphone 2017/08/03” indicating that the sales data related to the adjustment-report pane 91 has been transmitted to the store manager's smartphone and backed up. “2017/08/03” indicates the date when the sales data has been transmitted.

In the third line of the adjustment-report pane 91, the save information described with reference to FIG. 13 is printed. The save information is “Saved: card A 2017/08/03” indicating that the sales data related to the adjustment-report pane 91 has been saved in the card A and backed up. “2017/08/03” indicates the date when the sales data has been saved.

As described above, with the electronic cash register 8 equipped with a touch panel display, it is possible to easily grasp the backup state of sales data such as adjustment data and inspection data by similar operation to that in the first embodiment.

(Modification)

The present invention is not limited to the above embodiments, can be modified without departing from the gist of the present invention, and includes, for example, the following (a) to (d):

(a) The external apparatus for backing up data is not limited to a smartphone, and may be any device.

(b) The data to be backed up by the electronic cash register is not limited to inspection data and adjustment data, and may be any data to be printed on a receipt sheet for recording.

(c) The communication path with the external apparatus is not limited to a wireless path, and may be a wired path.

(d) The communication protocol with the external apparatus is not limited to Bluetooth (registered trademark) Low Energy, and may be Wi-Fi (registered trademark).

What is claimed is:

1. A sales data processing apparatus comprising:
a communication unit configured to transmit sales data to an external apparatus; and
a processor configured to cause a predetermined printer to print the sales data,
wherein
the processor causes the printer to print, together with the sales data, information indicating whether the sales data has been transmitted via the communication unit.

2. The sales data processing apparatus according to claim 1, wherein
the processor causes, when the sales data has been transmitted via the communication unit, the printer to print, together with the sales data, identification information of the external apparatus to which the sales data has been transmitted.

3. The sales data processing apparatus according to claim 1, wherein
the processor causes, when the sales data has been transmitted via the communication unit, the printer to print, together with the sales data, date/time information on which the sales data has been transmitted.

4. The sales data processing apparatus according to claim 1, wherein
the communication unit transmits, when an adjustment mode is designated, the sales data to the external apparatus as adjustment data corresponding to the adjustment mode, or transmits, when an inspection mode is designated, the sales data to the external apparatus as inspection data corresponding to the inspection mode.

5. The sales data processing apparatus according to claim 4, wherein
the processor informs, when the adjustment mode or the inspection mode is designated, whether the sales data is transmittable to the external apparatus by the communication unit.

6. The sales data processing apparatus according to claim 4, wherein
the processor accepts a print instruction of the sales data by the printer when the adjustment mode or the inspection mode is designated.

7. The sales data processing apparatus according to claim 6, wherein
the processor acquires sales data corresponding to sales at a time when the print instruction has been accepted, and causes the printer to print the acquired sales data together with information indicating whether the sales data has been transmitted.

8. The sales data processing apparatus according to claim 1, wherein
the processor causes the printer to print, together with the sales data, information indicating whether the sales data has been stored in an external storage medium.

9. The sales data processing apparatus according to claim 8, wherein
the processor causes the printer to print, together with the sales data, the information indicating whether the sales data has been transmitted via the communication unit and the information indicating whether the sales data has been stored in the external storage medium, so as to be adjacent to each other.

10. The sales data processing apparatus according to claim 1 further comprises
a storage unit configured to store the sales data and identification information of the external apparatus to which the sales data has been transmitted in association with each other.

11. The sales data processing apparatus according to claim 1, wherein
the processor causes, when the sales data has been transmitted via the communication unit, the printer to print, together with the sales data, information indicating a type of the sales data.

12. The sales data processing apparatus according to claim 11, wherein
the type of the sales data is either adjustment data or inspection data.

13. A sales data processing method comprising:
a transmission step of transmitting sales data to an external apparatus by a communication unit; and
a printing step of causing a predetermined printer to print, together with the sales data, information indicating whether the sales data has been transmitted.

14. A non-transitory computer-readable recording medium storing a program for causing a computer to execute:
a transmission step of transmitting sales data to an external apparatus by a communication unit; and
a printing step of causing a predetermined printer to print, together with the sales data, information indicating whether the sales data has been transmitted.
